(19) United States
(12) Patent Application Publication
(10) Pub. No.: US 2002/0050416 A1
(43) Pub. Date: May 2, 2002

(54) Lift truck

(76) Inventor: Frederick Lesley Brown, Stratford Upon Avon (GB)

Correspondence Address: LUNDEEN & ARISMENDI, LLP, PO BOX 131144, HOUSTON, TX, 77219-1144, US

(21) Appl. No.: 09/682,870

(22) Filed: Oct. 26, 2001

(30) Foreign Application Priority Data
Oct. 27, 2000 (GB) 0026260.0

(51) Int. Cl. B60K 17/354

(52) U.S. Cl. 180/246; 180/233

(57) ABSTRACT

A lift truck (10) including a pair of rear wheels (16) mounted on a body (12), and a pair of front wheels (36) rotatably mounted on opposing ends of an axle (40), such that the axes of rotation (42) of the front wheels are fixed relative to each other, the axle being capable of rolling relative to the body and being pivotable through substantially 90 degrees either side of a straight ahead position relative to the body to steer the truck, in which all four wheels can be driven.

### BACKGROUND OF INVENTION

The present invention relates to lift trucks, in particular forklift trucks.

Lift trucks are known and fall into two broad categories, building trucks and warehouse type trucks.

Building trucks are used outside to transport material around building sites. Typically, building trucks will have a mast with vertically moveable forks upon which the material can be lifted and carried.

Building sites have contrasting types of terrain, such as soft ground, rough ground and surfaces having loose material, in addition to the possibility of the terrain being wet and sloping. Therefore, building trucks have particular features which enable them to negotiate such terrain.

To operate over rough terrain, the building truck must have a suitably high ground clearance in addition to the suspension properties of pneumatic tires. The tire footprint loading of the building truck must be sufficiently low to prevent it from sinking into soft ground. Consequently, high flotation tires are employed, and the weight of the building truck is minimized, the weight being determined by the structural strength requirements of the truck.

To maintain traction over the various terrains, particularly when conditions are wet and the surface is inclined, building trucks employ drive to all four wheels. This is particularly necessary when taking into consideration the low weight of the building truck. Furthermore, the center of gravity is located at the approximately the central position of the building truck to load all four wheels evenly, thus ensuring each wheel is capable of providing tractive force.

Building trucks must also be sufficiently maneuverable, and generally have the ability to turn the forks up to a maximum of about 45 degrees either side of the forward direction. However, angles significantly above 45 degrees are not used since they tend to make the building truck unstable.

Building trucks are powered by gasoline or diesel driven internal combustion engines where the harmful emissions are diluted in the atmosphere.

Building trucks are not required to lift loads to very great heights because: (a) other forms of lifting devices are available, e.g., cranes; and (b) lifting a load to a significant height, when the building truck is on uneven ground is dangerous since the truck may tip over as the load is raised. The latter is particularly significant on building trucks, which have pneumatic tires (and hence allow roll or pitch of the truck body as the load is raised) and, as mentioned previously, building trucks are designed to be light (in line with strength requirements) and have a relatively high ground clearance (thus raising the center of gravity of the truck).

Conversely, warehouse type trucks are required to lift loads to significant heights and thus use a telescopic mast and fork arrangement to load and unload goods in loading bays, typically in the aisles of warehouses. To maximize space efficiency in the warehouse, the aisles are narrow, and goods are stacked vertically in the loading bay.

The conditions and the requirements of a lift truck in a warehouse, and the associated problems these conditions bring, contrast strongly with those conditions found on a building site and the requirements of a building truck.

Warehouses are inside and hence dry, the warehouse floor is generally hard and smooth, usually of concrete, as well as being flat. Therefore, there are no associated traction problems associated with the warehouse type truck when moving along an aisle, and for this reason warehouse type trucks employ drive to the two rear wheels.

Operating inside a warehouse requires warehouse type trucks to be powered by power sources where there are no harmful emissions, such as gas fueled internal combustion engines or electric motors. Therefore, it would be inappropriate to use a lift truck powered by a gasoline or diesel fueled internal combustion engine in a warehouse.

To maintain the stability of the warehouse type truck, particularly when it is loading and unloading goods into the loading bays, extra weight is added to the rear of the warehouse type truck. The combined extra weight and the weight of the heavy goods exhibits high loading on the tires of the warehouse type truck, and hence solid tires are used, i.e. non-pneumatic tires, which do not significantly deform during loading and unloading. Such tires exert high loadings on the ground, which must be sufficiently strong to resist such loads, hence, the use of concrete.

The added extra weight results in the center of gravity being located towards the rear of the truck. Thus, the stability of the truck is improved when steering at high steer angles.

The narrow nature of the warehouse aisles requires the warehouse type truck to operate in a severely restricted space, hence the warehouse type truck must be able to load and unload goods into loading bays, which are at 90 degrees to the aisle. This requires the front wheels and forks to be positioned at an angle of 90 degrees relative to the rear wheels.

A problem arises when power is applied to the rear wheels when the front wheels are angled at 90 degrees to the rear wheels, in that the front wheels tend to slip sideways relative to their normal direction of rotation, as opposed to steering the warehouse type truck into the loading bay as required. The truck tends to shuffle along the aisle resulting in the load becoming misaligned with its loading bay and the operator has to reverse and try again. This problem is more acute as the horizontal distance between the point about which the front wheels steer and the horizontal axis of the front wheels reduces. Thus, it is difficult to maneuver the goods into the loading bay.

### SUMMARY OF INVENTION

An object of the present invention is to provide an improved form of lift truck where this problem is reduced.

Thus, according to the present invention, there is provided a lift truck including a pair of rear wheels mounted on a body, and a pair of front wheels rotatably mounted on opposing ends of an axle, such that the axes of rotation of the front wheels are fixed relative to each other, the axle being capable of rolling relative to the body and being pivotable through substantially 90 degrees either side of a straight ahead position relative to the body to steer the truck, in which all four wheels can be driven.

A warehouse lift truck is provided comprising (1) a body, (2) a pair of rear wheels mounted on the body, (3) a pivot portion pivotably mounted on the body, wherein the pivot portion is pivotable through substantially 90 degrees either side of a straight-ahead position relative to the body to steer the truck, (4) an axle, (5) a pair of front wheels rotatably mounted on opposing ends of the axle, such that the axes of rotation of the front wheels are fixed relative to each other, and (6) means for driving each of the four wheels, wherein the axle is rollably mounted on the pivot portion so as to compensate for undulations in the flatness of the surface over which the wheels travel. Each front and rear wheel preferably has a solid tire.

The lift truck preferably further comprises a power source and wherein the means for driving each of the four wheels comprises at least one front motor for driving the front wheels and at least one rear motor for driving the rear wheels, wherein the at least one front motor and at least one rear motor are supplied power from the power source. Preferably, there are two front motors wherein the front wheels are each driven by a respective front motor. Alternatively or in addition, there are two rear motors wherein the rear wheels are each driven by a respective rear motor.

In one embodiment, the power source is an internal combustion engine. The engine preferably utilizes a gas fuel. The engine preferably drives hydraulic pump. The hydraulic pump is preferably a variable displacement pump, for example, swash-plate type pump. In this embodiment, the motors are preferably hydraulic motors to drive the wheels.

In another embodiment, the power source is a battery. The motors are electric motors.

In either of these embodiments, one rear wheel is preferably drivable in a reverse direction while the other rear wheel is driven in a forward direction.

In one preferred embodiment of the lift truck, the two front wheels have a front track, the two rear wheels have a rear track, and the front track is less than the rear track. In another preferred embodiment and preferably in addition, the two rear wheels have a rear track and the horizontal distance between the point about which the front wheels steer and the horizontal axis of the front wheels is equal to or less than one-half of the rear track.

In yet another embodiment, the lift truck preferably further comprises a lifting device mounted on the pivot portion, wherein the front axle is rollably mounted on the pivot portion so as to compensate for undulations in the flatness of the surface over which the wheels travel, thereby the front axle is capable of rolling relative to the body and lifting device. The lifting device preferably comprises a mast.

### BRIEF DESCRIPTION OF DRAWINGS

The invention will now be described, by way of example only, with reference to the accompanying drawings.

FIG. 1 is a side elevational view of a lift truck according to the present invention.

FIG. 2 is a plan view of the lift truck of FIG. 1.

FIG. 3 is an exploded partial front view of the lift truck of FIG. 1 showing various axes.

FIG. 4 is a schematic view of the drive arrangement of the lift truck of FIG. 1.

FIG. 5 is a plan view of the lift truck of FIG. 1 when loading goods into a loading bay.

### DETAILED DESCRIPTION

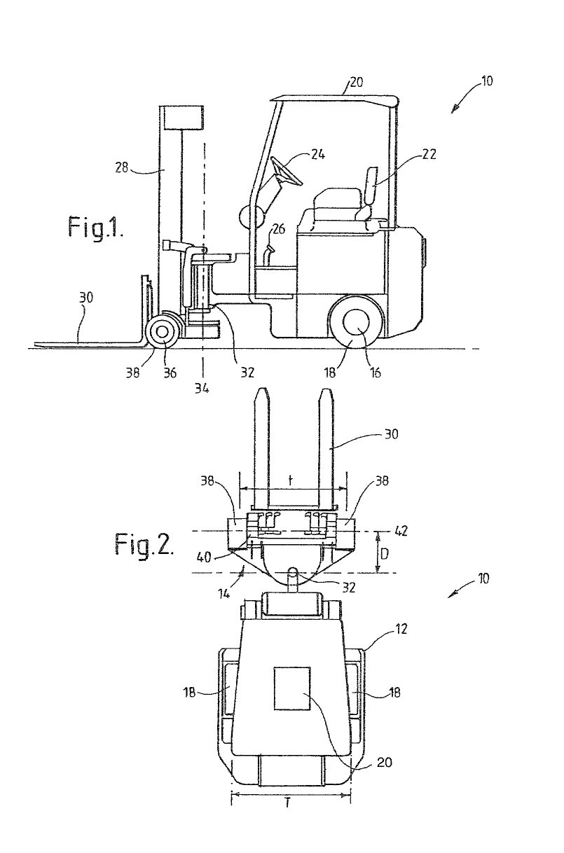

With reference to FIG. 1 and FIG. 2, there is shown a lift truck 10 comprising a body 12 and a lifting device 14.

The body 12 comprises a pair of rear wheels 16, the rear wheels 16 having solid tires 18, a cabin 20 housing a seat 22, steering controls 24, pedals 26 and lifting controls (not shown).

The lifting device 14 comprises a mast 28, forks 30, and a mechanism (not shown) for raising and lowering the forks 30 on the mast 28. The mechanism consists of a conventional telescopic construction and can be driven hydraulically. The lifting device 14 is pivotally attached to the body 12 at a pivot hinge 32 having a pivot axis 34.

The lift truck 10 further comprises front wheels 36, which are mounted below the lifting device 14. The front wheels 36 have solid tires 38, and are rotatably mounted on opposite ends of an axle 40. The front wheels 36 rotate about a common horizontal axis 42 to provide forward and reverse motion to the lift truck 10. Axis 42 is positioned at horizontal distance D forward of pivot axis 34.

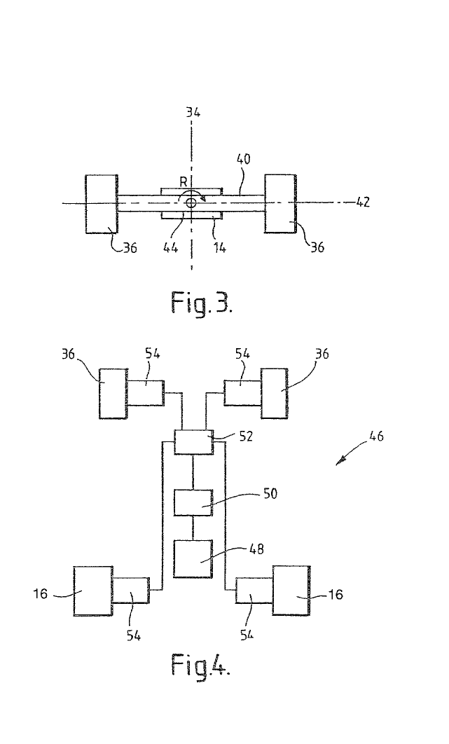

FIG. 3 shows that the axle 40 is pivotally fixed to the lifting device 14 via a pin and hole arrangement 44 at the mid-point of the axle 40. Thus, the axle 40 can roll relative to the lifting device 14, with the forward direction of the lift truck 10 being taken as the reference axis for the rolling direction (R). This rolling of the axle 40 compensates for small undulations in the flatness of the ground by allowing one wheel 36 to move up or down and correspondingly the other wheel 36 to move down or up relative to the pin and hole arrangement 44. Preferably, the amount of roll is less than plus or minus 10 degrees, for example, plus or minus 6 degrees, and more preferably less than plus or minus 5 degrees, for example, plus or minus 3 degrees. For example, if the axle 40 were about 500 mm long, the movement of one wheel 36 by plus or minus 25 mm or plus or minus 50 mm would correspond to approximately to an angle of plus or minus 3 degrees or plus or minus 6 degrees of roll, respectively.

Herein, the word “roll” and its variations rolling and rollably are used in the sense of pitch, yaw and roll. For example, your head moves in pitch when you make a “yes”motion. Your head moves in yaw when you make the “no”motion. Your head moves in roll when it moves “side-to-side”.

The pin and hole arrangement 44 is arranged relative to the pivot hinge 32 such that when the lifting device 14 pivots about the pivot axis 34, the axle 40, and hence the front wheels 36, also pivot about the pivot axis 34 to steer the truck.

Consideration of FIG. 2 shows that the track T (which is defined as the transverse distance between the centerlines of two wheels on same axis) of the rear wheels, is greater than the track t of the front wheels. Furthermore, the horizontal distance D is less than half the track T of the rear wheels.

The lifting device 14 and hence the front wheels 36 are driven about the pivot axis 34 by a hydraulic steer arrangement (not shown).

FIG. 4 shows a drive arrangement 46, which is provided for driving the front wheels, 36 and the rear wheels 16. Means is provided for driving any wheel in a forward or reverse direction.

The power source for the drive system in this embodiment is an internal combustion engine 48 powered by a gas fuel. The internal combustion engine 48 provides power to a hydraulic pump 50. The hydraulic pump 50 feeds a control unit 52, which in this embodiment is a valve arrangement (not shown), the control unit 52 providing a variable output to four hydraulic motors 54, each hydraulic motor 54 driving an associated front wheel 36 or rear wheel 16. The control unit 52 is arranged such that it can regulate power to each of the four wheels.

In other embodiments, the power source could be a battery (instead of the internal combustion engine 48), which in turn drives four electric motors (instead of hydraulic motors 54).

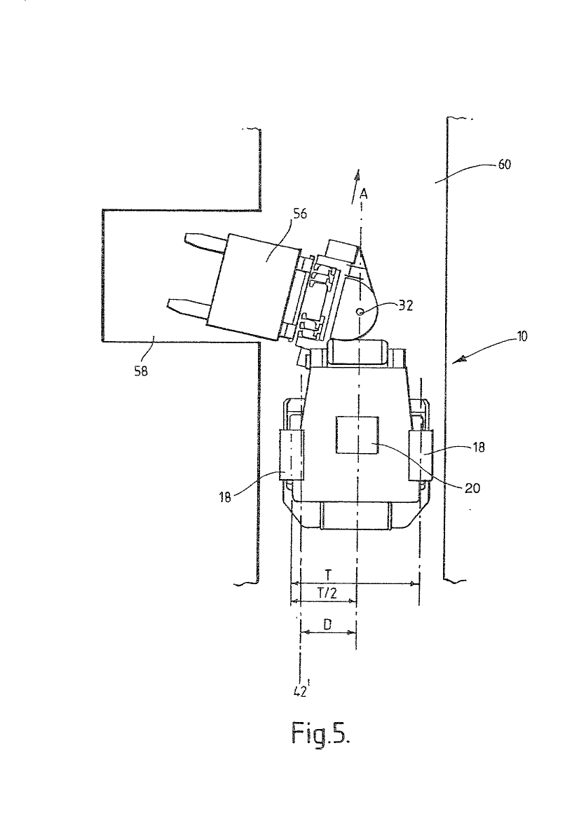

FIG. 5 shows the operation of the lift truck 10 when loading goods 56 into a loading bay 58, the lift truck 10 being positioned in a narrow aisle 60.

Consideration of FIG. 5 shows the position 42″ of the axis 42 relative to the body 12, when the front wheels are positioned at substantially 90 degrees to the body 12. It can be seen that the horizontal distance D is less than ½ T, the track of the rear wheels.

To maneuver the goods 56 into the loading bay 58, the lifting device 14 is rotated about the pivot axis 34. It is necessary to maneuver the lift truck 10 such that front wheels 36 are substantially at 90 degrees to the lift truck body 12 in order to position the goods 56 in the loading bay 58 since the aisle 60 is relatively narrow when compared with the width of the body 12.

When loading the goods 56 it is necessary to drive the front wheels 36 into the loading bay 58. By regulating and controlling the power to the front and rear wheels via the control valve arrangement, a balance can be obtained that provides enough power to the front wheels 36 to enable the front wheels 36 to drive into the loading bay 58.

The ability to control the power to the front wheels 36 prevents the front wheels from being forced sideways in the direction of arrow A along the aisle, i.e., in the direction of the rear wheels when the front wheels are positioned substantially at 90 degrees relative to the rear wheels.

The ability to drive the rear wheels in opposite directions while simultaneously driving the front wheels also considerably increases the maneuverability of the lift truck, enabling goods to be loaded and unloaded in confined spaces such as in the narrow aisle of a warehouse.

1] A warehouse lift truck, comprising:
a body;
a pair of rear wheels mounted on the body;
a pivot portion pivotably mounted on the body, wherein the pivot portion is pivotable through substantially 90 degrees either side of a straight-ahead position relative to the body to steer the truck;
an axle;
a pair of front wheels rotatably mounted on opposing ends of the axle, such that the axes of rotation of the front wheels are fixed relative to each other; and
means for driving each of the four wheels,
wherein the axle is rollably mounted on the pivot portion so as to compensate for undulations in the flatness of the surface over which the wheels travel.

2] A lift truck according to claim 1, further comprising a power source and wherein the means for driving each of the four wheels comprises at least one front motor for driving the front wheels and at least one rear motor for driving the rear wheels, wherein the at least one front motor and at least one rear motor are supplied power from the power source.

3] A lift truck according to claim 2, wherein the at least one front motor is two front motors and wherein the front wheels are each driven by a respective front motor.

4] A lift truck according to claim 3, wherein the at least one rear motor is two rear motors and wherein the rear wheels are each driven by a respective rear motor.

5] A lift truck according to claim 2, wherein the at least one rear motor is two rear motors and wherein the rear wheels are each driven by a respective rear motor.

6] A lift truck according to claim 2, further comprising a hydraulic pump, wherein the power source drives the hydraulic pump.

7] A lift truck according to claim 6, wherein the hydraulic pump is a variable displacement pump.

8] A lift truck according to claim 7, wherein the variable displacement pump is a swash-plate type pump.

9] A lift truck according to claim 6, wherein each of the at least one front motor and the at least one rear motor are hydraulic motors.

10] A lift truck according to claim 2, wherein the power source is an internal combustion engine.

11] A lift truck according to claim 10, wherein the internal combustion engine utilizes a gas fuel.

12] A lift truck according to claim 2, wherein the power source is a battery.

13] A lift truck according to claim 12, wherein each of the at least one front motor and the at least one rear motor is an electric motor.

14] A lift truck according to claim 1, wherein one rear wheel is driveable in a reverse direction while the other rear wheel is driven in a forward direction.

15] A lift truck according to claim 1, wherein the two front wheels have a front track, the two rear wheels have a rear track, and the front track is less than the rear track.

16] A lift truck according to claim 1, wherein the two rear wheels have a rear track and the horizontal distance between the point about which the front wheels steer and the horizontal axis of the front wheels is equal to or less than one-half of the rear track.

17] A lift truck according to claim 1, further comprising a lifting device mounted on the pivot portion, wherein the front axle is rollably mounted on the pivot portion so as to compensate for undulations in the flatness of the surface over which the wheels travel, thereby the front axle is capable of rolling relative to the body and lifting device.

18] A lift truck according to claim 17, wherein the lifting device comprises a mast.

19] A lift truck according to claim 2, wherein each wheel has a solid tire.
